(19) United States
(12) Patent Application Publication
(10) Pub. No.: US 2024/0320880 A1
(43) Pub. Date: Sep. 26, 2024

(54) IMPROVED METAL ARTIFACT REDUCTION THROUGH MOTION ARTIFACT COMPENSATION

(71) Applicants: DENTSPLY SIRONA Inc., York, PA (US); SIRONA Dental Systems GmbH, Bensheim (DE)

(72) Inventors: Ulrich SCHULZE-GANZLIN, Lorsch (DE); Susanne MAUR, Bensheim (DE); Markus HUELSBUSCH, Burstadt (DE)

(73) Assignee: DENTSPLY SIRONA Inc., York, PA (US)

(21) Appl. No.: 18/578,937

(22) PCT Filed: Jul. 5, 2022
(86) PCT No.: PCT/EP2022/068528

§ 371 Date: Jan. 12, 2024

(30) Foreign Application Priority Data
Jul. 12, 2021 (EP) 21184986.4

(51) Int. Cl. G06T 11/00; G06T 7/00

(52) U.S. Cl. CPC G06T 11/008; G06T 7/0012; G06T 2207/10072; G06T 2207/30036; G06T 2207/30168; G06T 2210/41; G06T 2211/424; G06T 2211/448

(57) ABSTRACT

Aspects relate to a method for reconstructing a digital volume tomography (DVT) imaging in the dental field including (S1) estimating the projection geometry from the sinogram of a patient imaging using motion artifact compensation (MAC); (S2) reconstructing a first volume using the estimated projection geometry; (S3) detecting the metal regions in the sinogram and in the first volume using the first volume and the estimated projection geometry; (S4) correcting the metal regions in the sinogram and generating a corrected sinogram; (S5) reconstructing a second volume with the estimated projection geometry and the corrected sinogram; and (S6) correcting the metal regions in the second volume.

### TECHNICAL FIELD OF THE INVENTION

The present invention relates to a method for reconstructing a digital volume tomography (DVT) imaging in the dental field. In particular, the present invention relates to the reduction of metal artifacts in a DVT imaging.

### BACKGROUND OF THE INVENTION

In a DVT imaging, the imaging components X-ray source and X-ray detector face each other and rotate around the patient. A sequence of X-ray projection images is generated, which form a sinogram. Knowing the projection geometry, a volume is reconstructed from the sinogram. The projection geometry describes the geometric properties of the DVT device and its trajectory during the exposure. It can be expressed by means of projection matrices.

In a DVT imaging, X-ray opaque structures such as metals lead to image artifacts in the reconstructed volume. The image artifacts occur when the sensitivity of the X-ray detector is not sufficient to image the X-ray attenuation physically accurately enough. This leads to problems especially behind strongly absorbing, so-called X-ray opaque structures, where noise predominates. This leads to inconsistent values in the reconstruction process, which often show up as stripe artifacts in the volume.

There are well-known software procedures for correcting these image artifacts, which are called metal artifact reduction (MAR) procedures here for simplicity. They replace the metal regions in the sinogram with plausible values so that the metal artifacts are reduced throughout the reconstructed volume. After reconstruction, the metal regions in the volume are replaced with plausible values.

Known metal artifact reduction techniques provide reduced quality if the patient moves during the DVT acquisition or the device is insufficiently calibrated. The reason for this is that many of the MAR methods project metal areas detected in the volume into the sinogram or vice versa. In the case of patient movement or insufficient device calibration, both the metal detection in the artifact-affected volume and the projection of the metal regions are inaccurate due to the incorrect consideration of the projection geometry. The inconsistencies in the reconstruction lead to significant remaining metal artifacts in the volume.

Due to the inaccurate projection geometry, too much or too little correction is made in the sinogram as well as in the volume, or the correction is made in the wrong place. To reduce the problems mentioned with inaccurate projection geometry, an enlargement of the detected metal regions or of an uncertainty range around the detected metal regions is usually performed. This leads to an additional inaccuracy of the MAR, since physically exactly measured areas of the sinogram are also replaced. The enlargement strength results from a maximum tolerated inaccuracy of the projection geometry.

### DISCLOSURE OF THE INVENTION

The objective of the present invention is to provide a method for reconstructing a digital volume tomography (DVT) imaging in X-ray cone beam computed tomography, thereby overcoming the aforementioned disadvantages of the prior art.

This objective has been achieved by the method according to claim 1. The subject-matters of the dependent claims relate to further developments and preferred embodiments.

The method according to the invention is for reconstructing a DVT imaging. It comprises the steps of: estimating the projection geometry from the sinogram of a patient imaging using motion artifact compensation (MAC); reconstructing a first volume with the estimated projection geometry; detecting the metal regions in the sinogram and in the first volume using the first volume and the estimated projection geometry; correcting the metal regions in the sinogram and generating a corrected sinogram; reconstructing a second volume with the estimated projection geometry and the corrected sinogram; and correcting the metal regions in the second volume.

A significant beneficial effect of the present invention is the improved correction of metal artifacts, which is due to the higher accuracy of the correction, and the consequent improved image quality of the reconstructed volume.

### BRIEF DESCRIPTION OF THE DRAWINGS

In the following description, the present invention will be explained in more detail with reference to exemplary embodiments and with reference to the drawings, wherein.

FIG. 1—shows a flow diagram according to one embodiment of the invention;

FIG. 2—shows a computer-aided DVT system on which the method according to the invention can be carried out;

FIG. 3a—shows an axial slice of a DVT volume without MAC with inadequately corrected metal artifacts from the prior art;

FIG. 3b—shows an axial slice of a DVT volume with MAC having distinctly contoured “metal” fillings, in accordance with one embodiment of the present invention.

The reference numerals shown in the drawings designate the elements listed below, which will be referred to in the following description of the exemplary embodiments.
1. DVT system
2. X-ray device
3. X-ray source
4. X-ray detector
5. Control unit
6. Head fixation
7. Bite
8. Computer
9. Display
a. Jaw arch
b. Tooth
c. Metal fillings
d Metal artifacts

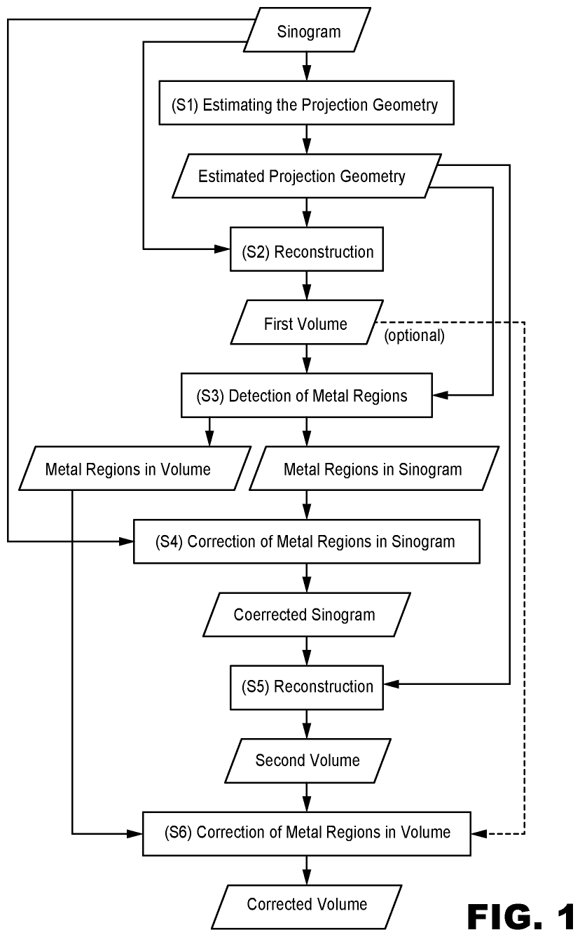

The method according to the invention (see FIG. 1) is used to reconstruct a digital volume tomography (DVT) imaging in the dental region. The method comprises the following steps: (S1) estimating the projection geometry from the sinogram of a patient imaging using motion artifact compensation (MAC); (S2) reconstructing a first volume using the estimated projection geometry; (S3) detecting the metal regions in the sinogram and in the first volume using the first volume and the estimated projection geometry; (S4) correcting the metal regions in the sinogram and generating a corrected sinogram; (S5) reconstructing a second volume using the estimated projection geometry and the corrected sinogram; and (S6) correcting the metal regions in the second volume.

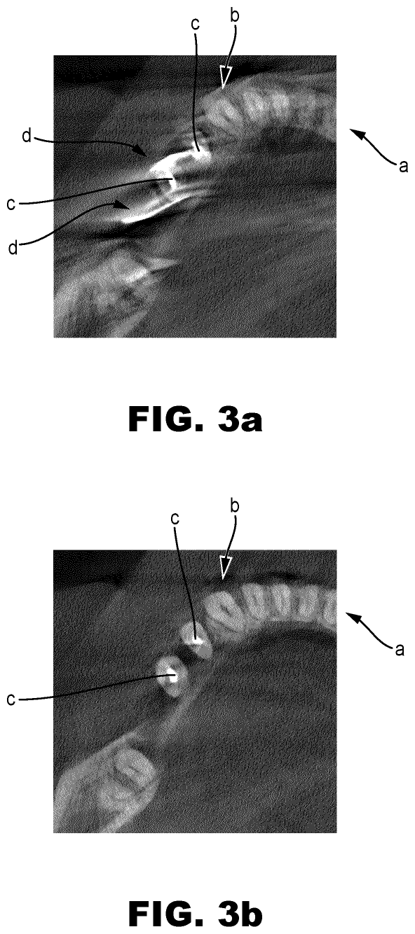

FIG. 3a shows an axial slice of a DVT volume reconstructed according to the prior art without MAC. FIG. 3b shows the same axial slice of the DVT volume generated by the method according to the invention with MAC. In FIG. 3b, the metal fillings (c) are evident with distinct contours. The metal artifacts (d) from FIG. 3a, which cover both the jaw arch (a) and the individual teeth (b), are clearly reduced in FIG. 3b.

In a preferred embodiment, the first volume differs from the second volume with respect to the resolution and/or the number of projections used and/or the image processing used. Here, the first volume is used exclusively for detecting the metal regions for the MAR and the second volume is used for visualization and further diagnosis. Thus, the first volume may be generated to save computational time and memory consumption with lower demands on the resulting image quality. In particular, when computing the first volume, the voxel resolution may be lower, subsampling of the projections may be performed, and image processing steps on the projections and/or the volume may be omitted.

In another preferred embodiment, the detection of the metal regions in the sinogram in step (S3) is performed by two sub-steps. These are: (S3.1) detecting the metal regions in the first volume preferably by using thresholds and/or the shape of the metal structures; and (S3.2) projecting the detected metal regions into the sinogram with the estimated projection geometry. The detection of the metal regions is easier in the volume than in the sinogram due to the superposition of the structures in the sinogram. By projecting the metal regions detected in the first volume into the sinogram with the estimated projection geometry, detection of the metal regions in the sinogram is achieved.

In a preferred alternative embodiment, the detection of the metal regions in the sinogram (4) in step (S3) is performed by three further sub-steps: These are (S3.1) generating a simulated sinogram of the first volume using the estimated projection geometry; (S3.2) detecting the metal regions in the simulated sinogram and transferring the detected metal regions to the sinogram; (S3.3) determining the metal regions in the first volume using the estimated projection geometry and the detected metal regions in the sinogram.

If the estimated projection geometry was used in the reconstruction of the first volume and in the generation of the simulated sinogram, the transfer of the detected metal regions from the simulated sinogram to the sinogram is trivial because the image regions are identical. Detection of the metal regions is easier in the simulated sinogram than in the sinogram because a simplified representation of the superimposed structures is achieved when generating the simulated sinogram. The metal regions detected in the simulated sinogram can be transferred to the sinogram because the projection geometries estimated for the sinogram were used in the generation of the simulated sinogram. By projecting the metal regions detected in the simulated sinogram into the first volume with the estimated projection geometry, a detection of the metal regions in the first volume is achieved.

In a further preferred embodiment, the correction of the metal regions in the sinogram in step (S4) is performed by one or more of the following sub steps: (S4.1) Filling the metal regions in the sinogram with new pixel values, which are either calculated from the neighboring pixels or correspond to artificial pixel values; (S4.2) Weighted blending of the new pixel values from the previous step (S4.1) with the pixel values of the sinogram. The metal regions in the sinogram cannot be physically measured correctly due to strong absorption. By replacing them with plausible pixel values, the occurrence of metal artifacts during the reconstruction can be avoided. The new plausible pixel values can be artificial values or calculated from neighboring pixels in the sinogram. A weighted blending of the new pixel values with the original pixel values preserves some of the uncertain physical information.

In a further preferred embodiment, the correction of the metal regions in the second volume in step (S6) is performed by one or more of the following sub steps: (S6.1) filling the metal regions in the second volume with values from the reconstructed first volume or artificial values; (S6.2) blending the new values from the previous step (S6.1) with the values of the second volume in a weighted manner.

Due to the replacement of the metal regions in the sinogram, the values in the metal regions in the reconstructed second volume are strongly falsified, they show a clearly too low absorption. By reinserting values from the first volume or replacing them with plausible, artificial values, the existence of the metal regions in the second volume is visualized. By a weighted blending of the new voxel values with the original voxel values a pleasing image impression is achieved.

In another preferred embodiment, the MAC comprises in step (S1) the following sub steps, which are preferably iteratively repeated until a convergence criterion is reached: (S1.1) reconstruction of a third volume with estimated projection geometry; (S1.2) estimation of the projection geometry by registration of the projection images of the sinogram with the third volume.

Patient movement or deviating device movements lead to deviations between the reconstructed volume and the projection images of the sinogram. The registration detects these deviations and compensates for them by adjusting the projection geometry. The adjustment of the projection geometry is done by varying geometric parameters. The geometric parameters preferably comprise intrinsic parameters and extrinsic parameters, where the intrinsic parameters describe the projective properties of the X-ray detector and the X-ray source relative to each other and the extrinsic parameters describe a transformation consisting of rotation and translation per projection image and selected sub-region of the volume. So-called “optimization methods” can be used as procedures for estimating the geometric parameters. The repeated reconstruction of the third volume with the adjusted projection geometry updates the reference volume for the registration. Possible convergence criteria are: a) whether the change of the projection geometry is smaller than a threshold value; b) whether the quality of the registration is larger than a threshold value; c) whether the number of iteration steps is larger than a threshold value; d) whether the computation time is larger than a threshold value.

Preferably, the MAC in step (S1) may describe the projection geometry to be estimated using projection matrices. Preferably, in step (S1), the MAC may estimate the projection geometry based on an existing geometric device calibration and supplement it with an additional rigid motion described by three rotation parameters and three translation parameters per projection image of the sinogram. Optionally, the intrinsic parameters can be estimated additionally.

In another preferred embodiment, registration of the projection images in step (S1.2) is performed by generating simulated sinograms using the estimated projection geometry and comparing them to the sinogram using similarity measures. In generating a simulated sinogram, a forward projection of the third volume is performed using the estimated projection geometry. When the correct projection geometry is applied, the similarity between the simulated sinogram and the sinogram is maximum. Several similarity measures are known in the literature to evaluate the similarity. Instead of a similarity measure, a negated difference measure can also be used. The following similarity or error measures can be applied in the registration procedure: Mean Square Error, Mean Absolute Difference, Normalized Cross-correlation, Gradient Correlation, Gradient Information, Gradient Information with linear Scaling, Gradient Orientation, Mutual Information.

In another preferred alternative embodiment, the MAC in step (S1) comprises estimating the projection geometry by evaluating metrics on one or more consistency constraints in the sinogram. Estimating the projection geometry by evaluating metrics on consistency constraints in the sinogram has the advantage that no reconstruction of a volume is required.

The following consistency constraints can be applied in the projection geometry estimation procedure: Data Consistency, Epipolar Consistency, Fourier Consistency, Grangeat's Theorem, Cross-correlation.

In another preferred alternative embodiment, the MAC in step (S1) comprises the following sub steps, which are preferably iteratively repeated: (S1.1) reconstructing a third volume with the estimated projection geometry; (S1.2) computing an image quality metric on the third volume, such as a sharpness measure or evaluating a smoothness condition; (S1.3) adjusting the estimated projection geometry to improve the image quality metric. Image quality metrics often correlate with the presence of motion artifacts. Improving image quality metrics by adjusting projection geometry can reduce motion artifacts. The adaptation of the projection geometry is done by varying geometric parameters, preferably in an iterative procedure.

Image quality metrics can be sharpness measures on the volume, such as gradient variance or gradient norm, or defined by smoothness constraints on the volume, such as entropy of gray values, variance of gray values, or total variation.

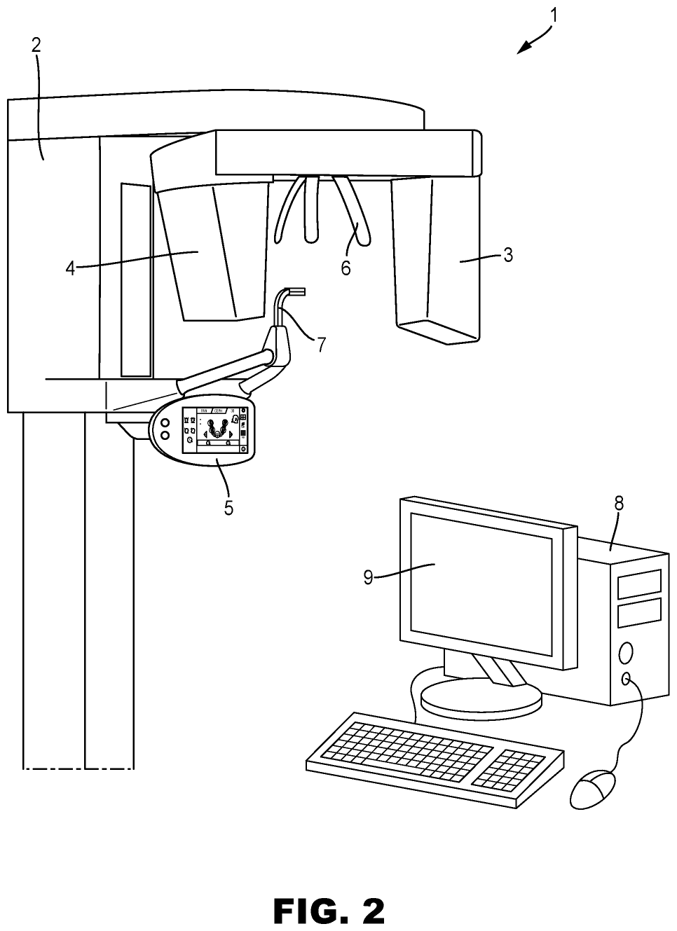

The method according to the invention is a computer implementable method, and can be executed on a computerized DVT system (1). FIG. 2 shows an example of an embodiment for a DVT system (1). In this regard, the present invention also includes a computer program having computer-readable code. The computer program may be provided on a data storage device. The computer-assisted DVT system (1) comprises an X-ray device (2) for performing patient imaging, whereby the sinogram is generated. The X-ray device (2) has an X-ray source (3) and X-ray detector (4), which are rotated around the patient's head during the exposure. The trajectory of the X-ray source (3) and X-ray detector (4) during the exposure may describe a circular path. Alternatively, it may assume a shape deviating therefrom. If several actuators are controlled simultaneously, a device trajectory around the patient's head that deviates from a pure circular path can be achieved. The patient's head is positioned in the X-ray device with the bite (7) and the head fixation (6). The computerized DVT system (1) comprises a control unit (5), preferably a computer (8) or a computing unit connectable to the X-ray device (2), and preferably a display (9), inter alia to visualize the data sets. The computer (8) may be connected to the X-ray device (2) via a local area network (not shown) or alternatively via the Internet. The computer (8) may be part of a cloud. Alternatively, the computer (8) may be integrated into the X-ray device (2). The computations may alternatively take place in the cloud. The computer (8) executes the computer program and provides the data sets, including for visualization on the display (9). The display (9) may be spatially separated from the X-ray device (2). Preferably, the computer (8) may also control the X-ray device (2). Alternatively, separate computers may be used for the control and the reconstruction.

According to the present invention, the data sets generated by the above embodiments may be presented to a physician for visualization, in particular for diagnostic purposes, preferably by means of a display (9) or a printout.

1. A method for reconstructing a digital volume tomography (DVT) imaging in the dental region, comprising:
(S1) estimating a projection geometry from a sinogram of a patient imaging using motion artifact compensation (MAC);
(S2) reconstructing a first volume with the estimated projection geometry; (S3) detecting metal regions in the sinogram and in the first volume using the first volume and the estimated projection geometry;
(S4) correcting the metal regions in the sinogram and generating a corrected sinogram;
(S5) reconstructing a second volume with the estimated projection geometry and the corrected sinogram; and
(S6) correcting the metal regions in the second volume.

2. The method according to claim 1, wherein the first volume differs from the second volume with respect to the resolution and/or the number of projections used and/or the image processing used.

3. Method according to claim 1, wherein in that the detection of the metal regions in the sinogram in (S3) comprises:
(S3.1) detecting the metal regions in the first volume preferably by using threshold values and/or a shape of the metal structures; and
(S3.2) projecting the detected metal regions into the sinogram with the estimated projection geometry.

4. The method according to claim 1, wherein the detection of the metal regions in the sinogram in (S3) comprises:
(S3.1) generating a simulated sinogram of the first volume using the estimated projection geometry;
(S3.2) detecting the metal regions in the simulated sinogram and transferring the detected metal regions to the sinogram;
(S3.3) determining the metal regions in the first volume using the estimated projection geometry and the detected metal regions in the sinogram.

5. The method according to claim 1, wherein the correction of the metal regions in the sinogram in step (S4) comprises one or more of:
(S4.1) filling the metal regions in the sinogram with new pixel values, which are either calculated from the neighboring pixels or correspond to artificial pixel values; (S4.2) weighted blending of the new pixel values from (S4.1) with the pixel values of the sinogram.

6. The method according to claim 1, wherein the correction of the metal regions in the second volume in step (S6) comprises:
(S6.1) filling the metal regions in the second volume with values from the reconstructed first volume or artificial values;
(S6.2) weighted blending of new values from the previous step (S6.1) with the values of the second volume.

7. Method according to claim 1, wherein the MAC in step (S1) comprises and iteratively repeats, until a convergence criterion is reached, the following:
(S1.1) reconstructing a third volume with estimated projection geometry;
(S1.2) estimating the projection geometry by registering the projection images of the sinogram with the third volume.

8. The method according to claim 7, wherein the registration of the projection images in step (S1.2) is performed by generating simulated sinograms with the estimated projection geometry and comparing them with the sinogram by similarity measures.

9. The method according to claim 1, wherein the MAC in (S1) performs an estimation of the projection geometry by evaluating metrics on one or more consistency constraints in the sinogram.

10. The method according to claim 1, wherein the MAC in (S1) comprises and iteratively repeats the following:
(S1.1) reconstructing a third volume with the estimated projection geometry; (S1.2) computing an image quality metric on the third volume;
(S1.3) adjusting the estimated projection geometry to improve the image quality metric.

11. A non-transitory computer readable storage medium storing a program, comprising instructions which when executed by a computer causes the computer to:
(S1) estimate a projection geometry from a sinogram of a patient imaging using motion artifact compensation (MAC);
(S2) reconstruct a first volume with the estimated projection geometry; (S3) detecting metal regions in the sinogram and in the first volume using the first volume and the estimated projection geometry;
(S4) correct the metal regions in the sinogram and generating a corrected sinogram;
(S5) reconstruct a second volume with the estimated projection geometry and the corrected sinogram; and
(S6) correct the metal regions in the second volume.

12. A computerized DVT system comprising an X-ray device (2) a processor configured to:
(S1) estimate a projection geometry from a sinogram of a patient imaging using motion artifact compensation (MAC);
(S2) reconstruct a first volume with the estimated projection geometry; (S3) detecting metal regions in the sinogram and in the first volume using the first volume and the estimated projection geometry;
(S4) correct the metal regions in the sinogram and generating a corrected sinogram;
(S5) reconstruct a second volume with the estimated projection geometry and the corrected sinogram; and
(S6) correct the metal regions in the second volume.

13. (canceled)
